(19) United States
(12) Patent Application Publication
(10) Pub. No.: US 2016/0104161 A1
(43) Pub. Date: Apr. 14, 2016

(54) Smart Credit Card with Enhanced Security Features

(71) Applicant: Alaina Butler, Indianapolis, IN (US)

(72) Inventor: Alaina Butler, Indianapolis, IN (US)

(21) Appl. No.: 14/874,787

(22) Filed: Oct. 5, 2015

Related U.S. Application Data
(60) Provisional application No. 62/062,998, filed on Oct. 13, 2014.

(51) Int. Cl. G06Q 20/40; G10L 17/00; G06Q 20/34; G06K 19/067; G06Q 20/24

(52) U.S. Cl. CPC G06Q 20/409; G06K 19/067; G06Q 20/24; G06Q 20/357; G06Q 20/40145; G10L 17/005

(57) ABSTRACT

A smart credit card. The credit card includes a power source, a memory, a processor, a logic, a magnetically readable strip, an identity sensor comprising at least one fingerprint reader on the front and rear of the card, and a capacitive display screen. The user stores identity information on the memory. The credit card is activated via the identity sensor. The identity sensor receives user identification information and the credit card activates after the logic confirms an identity match with the stored identity information. Upon activation, the user may use the credit card to initiate a transaction. The same credit card then enables the user to approve or cancel the transaction. The user approves the transaction by inputting a PIN or signing his or her name on the capacitive display screen. The credit card completes the transaction after authenticating the PIN or the user's signature through a security check.

### CROSS REFERENCE TO RELATED APPLICATIONS

This application claims the benefit of U.S. Provisional Application No. 62/062,998 filed on Oct. 13, 2014. The above identified patent application is herein incorporated by reference in its entirety to provide continuity of disclosure.

### FIELD OF THE INVENTION

The present invention relates to smart credit cards. More specifically, the present invention relates to a smart credit card including enhanced security features for preventing unauthorized user access.

### BACKGROUND OF THE INVENTION

Many people are victims of credit card theft or fraud, and as a result they may have to close their accounts and wait to reactivate the account until an investigation has been conducted. Further, the person may not be reimbursed for the purchases made on the credit card by an unauthorized user, causing the person to suffer a financial loss. Conventional credit cards can be easily used by unauthorized users and can be difficult to track or locate once lost. Devices are known in the prior art that relate to credit cards having security features. Such security features in the prior art generally relate to cards having fingerprint readers adapted to authenticate the user's identity enabling them to use the credit card to complete a transaction. These devices, however, do not provide a credit card that incorporates an identity sensor comprising a pair of fingerprint readers, at least two security measures, wherein the first security measure requires that the credit card be activated before displaying credit card information, a capacitive display screen that displays the credit card information upon activation, and a second security measure which enables the user to approve or cancel a transaction through a security check performed independently by the credit card.

### SUMMARY OF THE INVENTION

In view of the foregoing disadvantages inherent in the known types of credit cards now present in the prior art, the present invention provides a smart credit card wherein the same provides enhanced security features to prevent unauthorized users from completing transactions with the credit card. The present smart credit card includes a power source, a memory for storing user identity information, a magnetically readable strip wherein credit card information is stored, an identity sensor that comprises at least one fingerprint reader on the front and rear of the card, a capacitive display screen configured to display credit card information, such as the credit card number, date of expiration, and security code, a logic for matching user identity information relayed to the identity sensor with identity information stored on the memory and a processor for executing same. The credit card is issued to the user by a financial institution, which the user must verify with same upon receipt. Upon verifying the credit card the user may store identity information, such as fingerprints and vocal patterns on the credit card memory. The credit card includes at least two security measures in order to complete a transaction. The first security measure requires that the credit card user first activate the credit card and the second security measure requires that the user authenticate the transaction. Activating the credit card enables the user to swipe the credit card to initiate a transaction. Authentication enables the user to approve or cancel a transaction. In order to activate the credit card the user engages both fingerprint readers simultaneously. Once engaged the credit can be activated upon the logic confirming an identity match with the identity information relayed to the identity sensor with stored user identity information.

The capacitive display screen is configured to indicate whether the credit card has been activated and the user has been granted authorization to initiate a transaction. The capacitive display screen further allows the user to enter a PIN and write his or her signature via a capacitive stylus or another such implement. After the card has been activated and the user has swiped his or her credit card to initiate a transaction, the credit card then enables the user to authenticate the transaction by allowing the user to decide whether he or she indeed approves the transaction. The user approves the transaction by signing his signature on the credit card's capacitive display screen or entering a PIN and submitting it thereon. The credit card logic then runs a security check, wherein it confirms the submitted PIN with the PIN programmed by the user or confirms the submitted signature with the user's stored signatures as legitimate and authentic. The user may cancel the transaction by selecting a cancel input on the capacitive display screen. Authentication of the PIN or signature by the logic subsequently finalizes the transaction. Lastly, if an unauthorized user attempts to pull information from the credit card by hacking it or by using some illegal device, the credit card completely deactivates itself, thereby deleting all information stored thereon and preventing further activation of the card.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic view of the electronic components of the smart credit card of the present invention.

FIG. 2A shows a perspective front view of an embodiment of the present invention showing a fingerprint reader and a capacitive display screen wherein the display screen displays credit card information.

FIG. 2B shows a perspective back view of an embodiment of the present invention showing a fingerprint reader and magnetic readable strip.

FIG. 3 shows a flow chart illustrating, generally, the cycle by which the present invention undergoes in any transaction.

FIG. 4 shows a flow chart of the activation step of the present invention.

FIG. 5 shows a flow chart of the authentication step of the present invention.

### DETAILED DESCRIPTION OF THE INVENTION

Reference is made herein to the attached drawings. Like reference numerals are used throughout the drawings to depict like or similar elements of the smart credit card. The figures are intended for representative purposes only and should not be considered to be limiting in any respect.

As used herein, “logic” refers to (i) logic implemented as computer instructions and/or data within one or more computer processes and/or (i) logic implemented in electronic circuitry. In the interests of economy, the present disclosure refers to “a processor,” and so on. However, this should not be read as limiting in any way as the present disclosure contemplates embodiments of the present invention utilizing “one or more processors,” and so on. Unless specifically limited to a single unit, “a” is intended to be equivalent to “one or more” throughout the present disclosure.

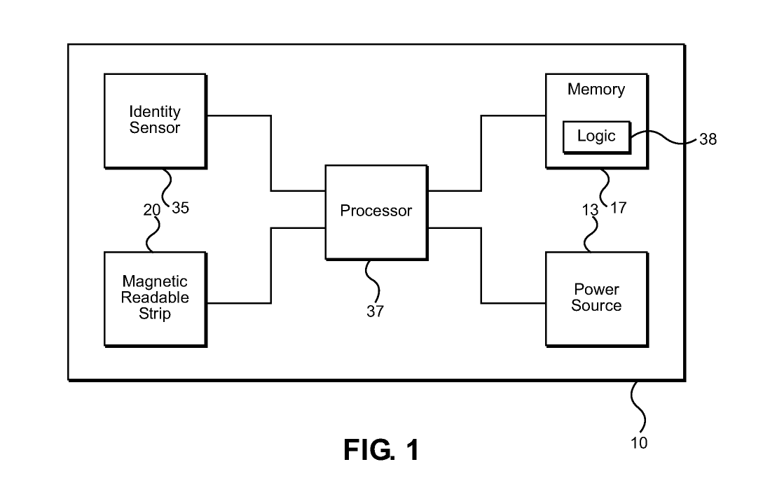

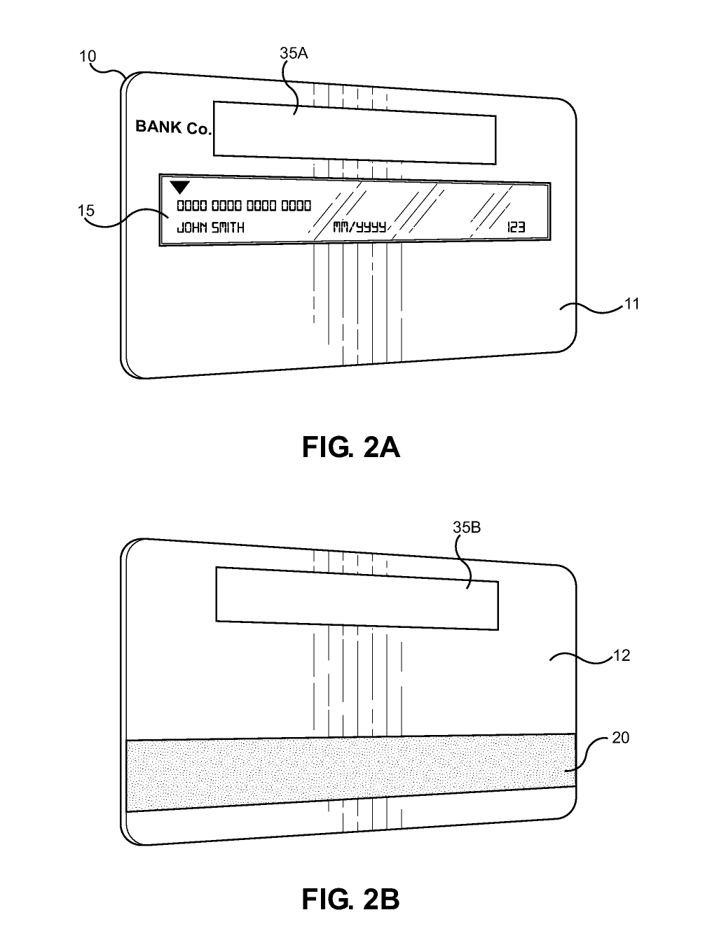

Referring now to FIGS. 1-2, there are shown a schematic representation of the electronic components as well as views in accordance with one embodiment of the present invention. The credit card comprises a credit card body 10, a power source 13, a capacitive display screen 15 disposed on the front surface 11 of credit card body 10 and configured for displaying, among other things, credit card information, a memory 17 for storing the user's identity information, a magnetic readable strip 20 disposed on the lower rear surface 12 of the credit card body 10 and configured to store credit card data, an identity sensor 35, a processor 37, and a logic 38.

Referring now to FIGS. 2A-2B, there is shown two views of one embodiment of the present invention. The identity sensor 35 comprises at least two fingerprint readers 35A, 35B, wherein at least one fingerprint reader 35A is disposed on the upper front surface 11 of the credit card body 10 and at least one fingerprint reader 35B is disposed on the upper rear surface 12 of the credit card body 10. The fingerprint readers 35A, 35B are strips disposed horizontally along the upper surfaces of the front 11 and back 12 of the credit card body 10, such that the user can make contact with the fingerprint readers 35A, 35B naturally, such as when grabbing the credit card from a pocket, a wallet or holding it in a position which is ready for swiping. For example, a user may engage the fingerprint readers 35A, 35B by grabbing and holding the credit card body 10 in between a thumb and index finger so that the user's thumb makes contact with the fingerprint reader 35A and the user's index finger makes contact with the fingerprint reader 35B. The fingerprint readers 35A, 35B are adapted to sense and read any of the user's fingers and generate an electrical representation related thereto. The fingerprint readers 35A, 35B are not limited to reading the user's thumb and index finger, only. Indeed, in an alternative embodiment, the identity sensor 35 has more than one fingerprint reader disposed on the front surface 11 and the rear surface 12 of the credit card body 10, wherein each fingerprint reader is configured to read a specific finger of the user. In a second embodiment, the identity sensor 35 comprises a voice recognition sensor, which is adapted to sense and recognize the user's vocal patterns. The voice recognition sensor generates an electrical representation of the user's vocal patterns. In a third embodiment, the identity sensor 35 comprises both fingerprint readers and a voice recognition sensor.

The memory 17 is configured to store the user's signature, fingerprints, and vocal patterns. In one embodiment of the invention, the credit card is provided to a user by a financial institution issuing such smart credit cards. In order to store this information on the memory 17, the user must first enable the credit card for use via a verification process, in which the financial institution confirms the user's identity and sends a signal to the credit card, thereby enabling its use. First, the financial institution provides the user a temporary PIN sent separate from the credit card. Next, the user contacts the financial institution's verification line which verifies the user's identity by confirming the temporary PIN provided and asking the user several questions relating to his or her date of birth, social security number, home address, and telephone number. In another embodiment, this credit card verification process is not required. In an alternative embodiment, this verification process can be conducted over the phone or in person with a banker at any branch of the financial institution or through any of the financial institution's ATMs. Upon user verification, the financial institution transmits a signal to the credit card's power source 13, which enables the user to program the credit card with his signature, fingerprints and vocal patterns and store such information in the credit card memory 17. For example, in an alternative embodiment, the credit card will be enabled after user verification and the user will be allowed to input a variety of his or hers signatures onto the capacitive display screen 15, which the card will register and store on the credit card memory 17 as the user's authentic signatures.

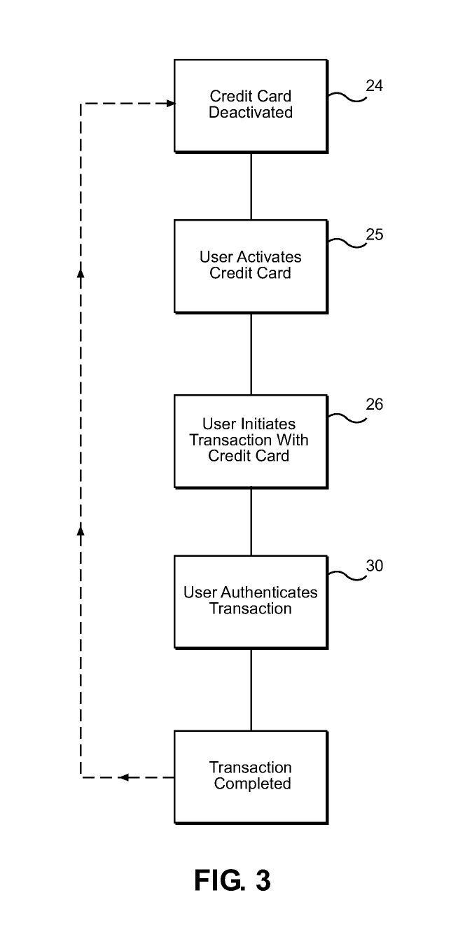

Referring now to FIG. 3 there is shown a flow chart of the cycle by which the present invention undergoes in completing a transaction. When not in use, the credit card remains in a deactivated state 24. The user makes use of the credit card by activating it 25. The user initiates a transaction 26 by swiping the credit card on a merchant's credit card machine, inserting the credit card into an ATM, or inputting the credit card information in a merchant's online server. The user authenticates the transaction 30 by approving it, which completes the transaction. Lastly, after the transaction is completed, the credit card returns to its deactivated state 24.

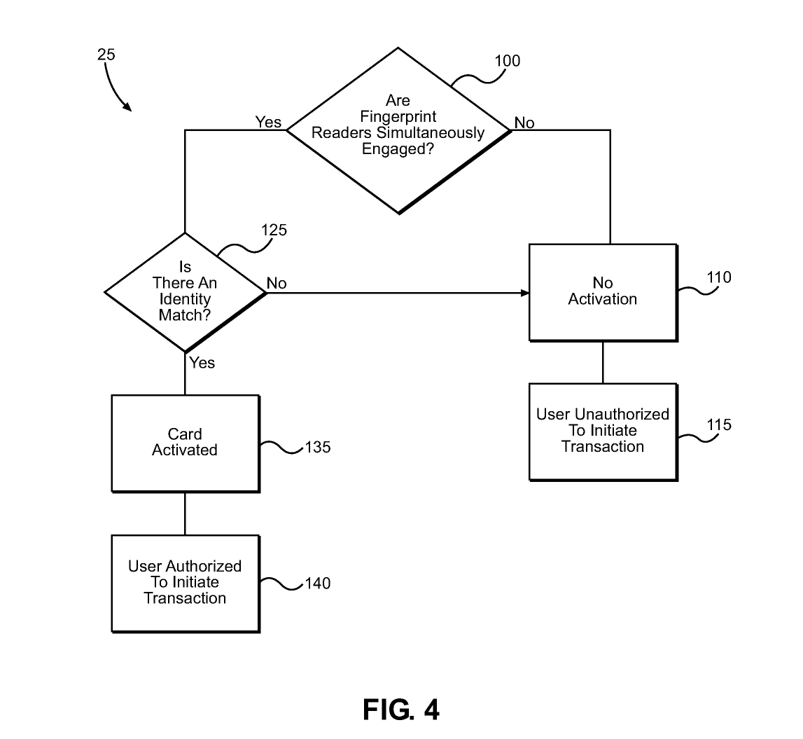

Referring now to FIG. 4, there is shown a flow chart of the activation step 25 of the depicted embodiment wherein the identity sensor comprises a pair of fingerprint readers disposed on the front and rear, respectively, of the credit card. Activation step 25 is triggered when the user simultaneously engages the fingerprint readers. If the user does not simultaneously engage the fingerprint readers the card cannot become activated 110 and the user is prevented from initiating any transaction 115. If the user simultaneously engages 100 the fingerprint readers, the credit card subsequently undergoes an identity check which determines whether there is an identity match 125 by confirming a match between the fingerprint data relayed to the identity sensor by the user with the fingerprint identity information that the user has programmed and stored onto the credit card memory. During the identity match decision 125, the fingerprint readers generate an electrical representation of the user's thumb and index finger. In alternative embodiments the fingerprint readers generate an electrical representation of the user's other fingers. The fingerprint readers transmit the electrical representation to the processor. The logic retrieves from the memory the fingerprint data stored after verification. The logic compares the retrieved fingerprint information to the acquired fingerprint representation. If the logic fails to confirm an identity match, the credit card will not activate 110 and the user will be unauthorized to initiate a transaction 115. If the logic confirms an identity match, the credit card will activate 135 and the user will be authorized to initiate a credit card transaction 140. Authorization to initiate a credit card transaction 140 means that the user can swipe his or her credit card to transmit payment information via the magnetic readable strip in order to purchase a product or good. In one embodiment, the user retains authorization to initiate a transaction 140 as long his fingers remain simultaneously engaged with the identity sensor. In an alternative embodiment, the user may program the credit card to provide him or her with authorization 140 for a prolonged period of time, even after removing his or her fingers from the identity sensor. In one embodiment, this period of time is programmable using a setting disposed on the capacitive display screen.

When the user simultaneously engages 100 the fingerprint readers the capacitive display screen is powered on through the power source. Depending on whether there is an identity match, the credit card logic sends a signal to the capacitive display screen, creating a visual indicia thereon that indicates that the user is either authorized or unauthorized to initiate a transaction. If authorized, the logic subsequently sends a signal to the capacitive display screen, which creates a visual indicia displaying the credit card information, such as the card number, date of expiration and security code. If the user is unauthorized, the capacitive display screen does not show the card information and the credit card logic automatically returns the credit card to its deactivated state.

In an alternative embodiment, wherein the identity sensor comprises a voice recognition sensor, the user triggers the activation step 25 by speaking into the credit card. When the credit card is spoken into, the logic matches the electronic representation of the user's vocal patterns generated by the vocal recognition sensor with the vocal patterns that the user has programmed and stored in the memory. If the vocal patterns match, then an identity match will be confirmed 130 and the card will be activated 135, thereby authorizing a user to initiate a transaction 140. In alternative embodiments, the voice recognition sensor requires the user to speak a correct password, PIN or other activation command. In addition to confirming the user's vocal patterns, the logic confirms that the user has spoken the correct PIN or password that the user stored on the memory after the verification process.

In an alternative embodiment, the present invention includes an input for entering a PIN. The input comprises a keyboard located on the capacitive display screen. The keyboard is a touch keyboard utilized in conjunction with the voice recognition sensor for activating the credit card 135. In order to activate the credit card 135, the user enters a PIN on the keyboard and speaks into the credit card. The credit card logic determines whether the inputted PIN matches the PIN that was programmed after the credit card verification process and whether the inputted vocal pattern matches the user's stored vocal patterns. If the credit card logic confirms a correct PIN and vocal pattern match, the credit card will activate 135, thereby authorizing the user to initiate a transaction 140.

In an alternative embodiment, wherein the identity sensor comprises the fingerprint readers and the voice recognition sensor, the user may use either the voice recognition sensor or the fingerprint readers as alternative means of activating the credit card 135 and obtaining authorization to initiate a transaction 140. Either sensor may be utilized to activate the credit card 135 in the event the other is not working properly.

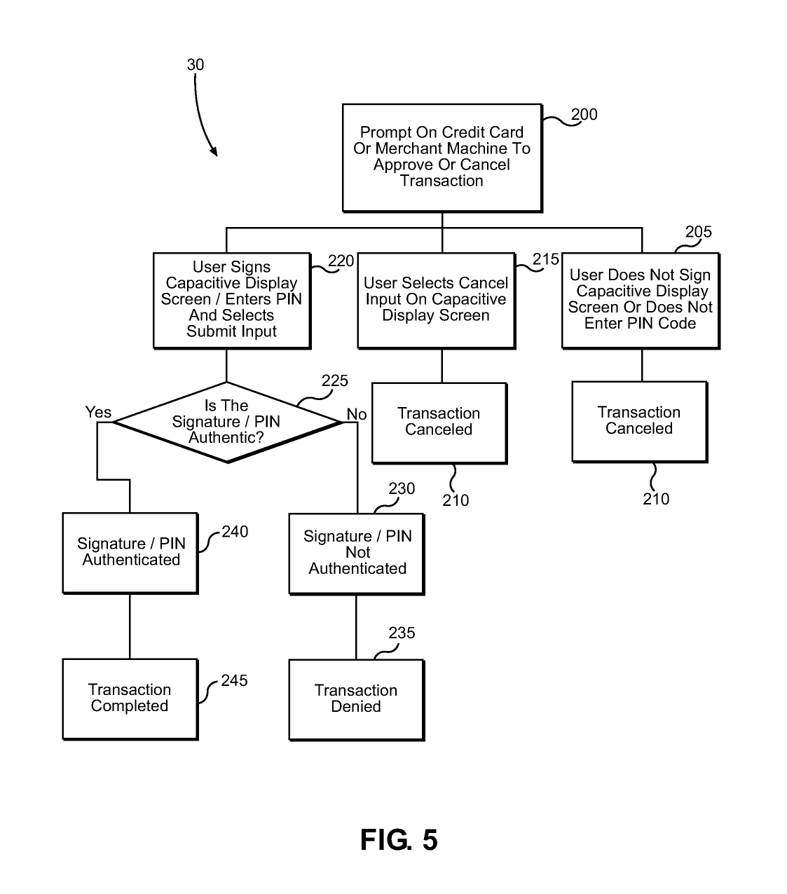

Referring now to FIG. 5, there is shown a flow chart of the authentication step 30. Once the user has activated the credit card and has gained authorization to initiate a transaction the user then swipes the credit card to initiate a transaction. At this moment, the authentication step 30 is triggered. When the credit card is swiped, the magnetic readable strip generates an electrical signal to the processor. The processor then sends an electrical signal to the capacitive display screen which provides visual indicia that prompts the user to approve or cancel the transaction 200. The user approves the transaction by signing his or her name or by entering a PIN 220 on the capacitive display screen. After signing his or her name, the user submits the signature for authentication by pressing a submit input on the capacitive display screen. The user can also cancel the transaction 210 by selecting a cancel input on the capacitive display screen 215 or simply by doing nothing when prompted to approve the transaction 205. In an alternative embodiment, wherein the identity sensor includes a voice recognition sensor, the voice recognition sensor is configured to enable the user to cancel a transaction 210 by speaking a canceling voice command into the voice recognition sensor. The voice recognition sensor generates an electrical representation of the inputted vocal patterns and the logic cancels the transaction if it confirms a vocal pattern match with the vocal patterns the user stored in the memory. In alternative embodiments, the user can program the credit card to remain on during the authentication step 30 for a prescribed period of time. For example, the user can program the card to stay on until he or she actually approves or cancels the transaction, or the user may program the credit card to stay on for one minute after a transaction is initiated, thereby giving the user only one minute to either approve or cancel the transaction. If the time lapses, then the transaction is canceled 210. This time is programmable using a setting disposed on the capacitive display screen. In alternative embodiments, when the card is used in an ATM, and the ATM holds the credit card within the machine, the authentication step 30 is conducted via the ATM. The ATM prompts the user to enter his pin in order to approve or cancel the transaction. The user approves the transaction via entering a PIN on the ATM machine keypad.

If the user approves the transaction by submitting his or her signature 220 on the capacitive display screen the credit card then runs a security check 225 to confirm that the PIN or the user's signature is authentic. During the security check 225 the credit card logic determines whether the user's signature matches the signature the user stored within the credit card memory after the credit card verification process. In this step, the capacitive display screen transmits an electrical representation of the user's inputted signature. The logic retrieves from the memory the user's signature data stored after verification. The logic compares the retrieved signature information to the inputted signature. If the logic fails to confirm a match between the signatures, the user's signature will not be authenticated 230 and the transaction will be denied 235. If the logic confirms a match between the signatures, the user's signature will be authenticated 240 and the transaction will be completed 245. The logic authenticates the PIN by determining whether it matches the PIN which the user stored in the memory after verification. Upon completion of a transaction the credit card immediately enters its deactivated state. If the user wishes to initiate another transaction he or she must reactivate the credit card and proceed through the activation step 25 anew.

In an alternative embodiment, when the credit card information associated with the credit card is used to initiate a transaction when the card is not activated, for example, when the credit card owner provides someone the credit card information associated with the credit card to complete a purchase over the phone or online but the credit card is not physically used for the purchase, the credit card prompts the user on the capacitive display screen that a transaction is occurring. However, instead of prompting the user to either approve or cancel the transaction 200, as illustrated above, the credit card prompts the owner to either approve or decline the transaction. The user is prompted when the merchant inputs the credit card information into its credit card processor or when the user containing the information associated with the credit card submits the credit card information into an online merchant credit card processor in an attempt to complete a transaction.

In this embodiment, the credit card comprises a wireless transceiver that is configured to receive an electronic communication from a credit card processor each time the credit card processor receives a request to charge the account associated with the credit card. The communication contains the information related to the sale in which the merchant processor is attempting to process including, but not limited to, the name of the merchant and the price. The transceiver subsequently sends a signal to the capacitive display screen, which displays the information to the user and prompts him or her to either approve or decline the transaction. If the owner is aware of the transaction and approves of it, he or she approves the transaction in the same manner as described in the authentication step 30, above, and subsequently completes the transaction. However, if the owner does not approve the transaction than he or she selects the decline input. The logic then rejects the transaction and notifies the financial institution issuing the credit card via an electronic communication that a fraudulent transaction was attempted. If the owner is completely unaware of the transaction and does nothing to either approve or decline the transaction, for example, because the credit card is stored in the user's wallet or purse while the user is being prompted to the transaction, then the transaction is declined after the time programmed by the user and the financial institution is notified. This security measure is provided for preventing unauthorized users who have somehow illegally obtained the credit card information from being able to use the credit card information to actually complete a transaction.

An alternative embodiment of the present invention includes a proximity sensor. The proximity sensor is disposed on the credit card and can be configured to restrict use of the card to an area proximal to a specific location, e.g. the user's home or business, or to a specific area, e.g. the town, county, state or country in which the user resides. In one embodiment of the present invention, the user can program this setting via the capacitive display screen after the credit card verification process. The proximity sensor works after a credit card has been activated. After activation and the credit card has been used to initiate a transaction, the credit card logic retrieves the programmed restriction input from the memory and determines whether the credit card is being used outside of that area via a GPS system or another such location-determining system or method. If the logic determines that the credit card has been swiped or used outside of the area programmed by the user, the logic will automatically decline the transaction and notify the financial institution issuing the credit card. The user can disable the proximity sensor to enable use of the credit card in any location. With the proximity sensor enabled, an unauthorized user will be unable to use the credit card in remote locations.

In an alternative embodiment of the present invention the credit card comprises a wireless transceiver and a storage memory disposed on the credit card, which is configured to record or log each transaction either completed by the user, initiated by the user, or attempted by an unauthorized user. The storage memory is configured to record the name of the store in which the card is used, the geographic location of that store, the purchase amount, and the time of the transaction or any combination thereof. The wireless transceiver picks up Wi-Fi networks providing the credit card with an internet connection and thereby transmitting the transaction history data to a designated electronic source therewith. In alternative embodiments, the transaction history data is transmitted by the transceiver via the cloud, a text message, email, a push notification, or another such form of electronic communication. The storage memory will record all transaction activity throughout the day and will then transmit the transaction history to a designated electronic source, such as smart phone, tablet, or watch, which the user has programmed the credit card to send the transaction data to.

An alternative embodiment of the present invention includes a menu disposed on the capacitive display screen. The menu contains a list of settings or options including, but not limited to, transactions, proximity, and home. The user can select any of the listed options from the menu to gain access to the information or user settings stored therein. For example, in one embodiment, the user may select a transaction option on the menu and access a record of purchases made using the credit card history information and/or adjust the settings according to his preferences. In an alternative embodiment, the user may select the proximity option to access the proximity settings and adjust the proximity with which the present credit card can be used.

In an alternative embodiment of the present invention, the logic further comprises an alert system with a wireless transceiver. The wireless transceiver picks up Wi-Fi networks providing the credit card with an internet connection. Using the internet connection, the alert system alerts the user, the financial institution which supplied the credit card, or both of fraudulent activity when detected. The alert is transmitted via a text message, email, a push notification, or another such form of electronic communication to a designated electronic device, such as a smart phone, tablet, or watch, which the user has programmed the credit card to send alerts to. The credit card logic determines that there is fraudulent activity when there are multiple failed attempts to activate the credit card, when a transaction was initiated without activating the credit card, i.e., the credit card information stored on the magnetic readable strip was stolen by an illegal means, such as by hacking or by an illegal machine or device, when the signature or PIN submitted to approve a transaction during the authentication step does not match the programmed information relating to same, and when the credit card is used outside of the proximity range programmed by the user. After the logic detects fraudulent activity it sends a sends a signal to the wireless transceiver which then sends the alert to the designated electronic device.

In an alternative embodiment of the present invention the credit card comprises a deactivation system, wherein the credit card processor completely deactivates the credit card in such a manner that the card is incapable of being activated again after fraudulent activity is detected by the credit card. The credit card logic determines that there is fraudulent activity as illustrated above and sends a signal to the processor which then deactivates the power source, thereby preventing the user from activating the card. Additionally, the credit card logic deletes all information stored on the credit card memory, such as the user's programmed identity information, including fingerprints, signatures, vocal patterns, and PINs as well as all credit card information, including the card number, date of birth, security code, and bank account number.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A credit card having a body, comprising:
a processor;
a memory;
a logic;
a magnetically readable strip;
a capacitive display screen;
an identity sensor configured to sense user identity information, comprising:
a first fingerprint reader on a first surface of the credit card; and
a second fingerprint reader on a rear surface of the credit card;
wherein simultaneous engagement of the first fingerprint reader and the second fingerprint reader causes the credit card to perform a method, the method comprising the steps of:
matching user identity information received by the identity sensor with user identity information stored on the memory to enable a user to initiate a transaction; and
matching user identity information relayed to the capacitive display screen with user identity information stored on the memory to complete the transaction.

2) The credit card as claimed in claim 1, wherein the identity sensor further comprises a voice recognition sensor, the voice recognition sensor configured to sense a user's vocal patterns.

3) The credit card as claimed in claim 1, wherein the identity sensor further comprises an input, the input operable by a capacitive keyboard.

4) The credit card as claimed in claim 1, further comprising a proximity sensor configured to prevent the initiation of transactions when the credit card is outside a prescribed area.

5) The credit card as claimed in claim 1, further comprising:
a wireless transceiver; and
an alert system configured to detect the occurrence of fraudulent activity and send an alert via the wireless transceiver to a designated electronic device.

6) The credit card as claimed in claim 1, further comprising:
a wireless transceiver;
wherein the memory is adapted to record each credit card transaction or attempted transaction and transmit the recorded transactions via the wireless transceiver to a designated source.

7) The credit card as claimed in claim 1, further comprising:
a deactivation system configured to delete the user identity information stored in the memory and deactivate the power source when fraudulent activity is detected.
